(19) United States
(12) Patent Application Publication
(10) Pub. No.: US 2013/0027180 A1
(43) Pub. Date: Jan. 31, 2013

(54) SEAMLESS AUTHENTICATION SYSTEM

(71) Applicants: Vijaya Ramaraju Lakamraju, Longmeadow, MA (US); Nicholas Charles Soldner, West Hartford, CT (US); Sanjay Bajekal, Simsbury, CT (US)

(72) Inventors: Vijaya Ramaraju Lakamraju, Longmeadow, MA (US); Nicholas Charles Soldner, West Hartford, CT (US); Sanjay Bajekal, Simsbury, CT (US)

(21) Appl. No.: 13/520,272

(22) PCT Filed: Mar. 2, 2010
(86) PCT No.: PCT/US10/00628

§ 371 Date: Jul. 2, 2012

(51) Int. Cl. G06F 7/04; H04B 10/00

(52) U.S. Cl. 340/5.53; 340/5.7; 340/5.61; 340/5.52; 398/106

(57) ABSTRACT

A system and method for providing access to or from a controlled space includes a device, a credential, a sensor, and a controller. The credential identifies or is associated with a user of the system and the device is configured

### BACKGROUND

The present invention relates to communication systems, and more particularly, to a security system that provides access to or from a controlled space.

There are many security or access control systems for locking and unlocking doors or portals, such as those used for ingress and egress from commercial buildings, residential buildings, and motor vehicles. Electronic security systems typically employ a credential in the form of a card in combination with a magnetic stripe card reader or a low range (generally less than 10 cm) smart card reader. A numeric keypad requiring the user to enter a pin code can be employed in combination with the card/reader or as a standalone security measure.

The card reader is typically wall mounted next to the door or is part of the door lock and the credential is carried by the user. In such an arrangement, the reader can be either be line or battery powered, and the credential is generally passive (battery-less). Security systems with similar functionality utilizing active credentials also exist.

Conventional security systems employing passive or active credentials typically suffer from several drawbacks or undesirable features. For example, security systems with active credentials are expensive and are life-limited due to the use of primary or secondary batteries. Additionally, most security systems require “non-value added” actions by the user to open a secured door. As a consequence of these non-value added actions, the user cannot open the secured door in one smooth, natural motion by simply turning the door handle (as if the door were unlocked) or by coming into contact with a specific area of the door. Instead, the user must physically locate the credential and place it either in or near the card reader or, alternatively, enter a pin code. These non-value added actions can greatly slow the entry or exit of the user.

### SUMMARY

A system for providing access to or from a controlled space includes a device, a credential, a sensor, and a controller. The credential identifies or is associated with a user of the system and the device is configured to detect the credential. The sensor detects the presence of the user adjacent to an entrance to or exit from the controlled space. The controller is responsive to both the device and the sensor to make an access decision prior to an attempt by the user to enter or exit the controlled space.

In another aspect, a system for providing access to or from a controlled space includes a credential, a reader module, a passive infrared sensor, and a controller. The credential sends and receives signals and is configured to be worn or carried by a user. The reader module sends and receives signals to detect the credential. The passive infrared sensor is adapted to detect the presence of the user adjacent an entrance to or exit from the controlled space. The controller is responsive to the passive infrared sensor to direct the signals of the reader module toward the user.

In another aspect, a method for providing access to or from a controlled space includes a credential that is detected to identify the presence of a user. A user intent to access the controlled space is determined based on a sensed presence of the user adjacent an entrance to or exit from the controlled space. A lock mechanism is controlled to unlock or remain locked prior to an attempt by the user to enter or exit the controlled space based on both the presence of the credential and the determination of user intent.

### BRIEF DESCRIPTION OF THE DRAWINGS

FIG. 1A is a diagrammatical view of a user approaching a door that utilizes a first embodiment of an access control system.

FIGS. 1B and 1C are a diagrammatical view of the user from FIG. 1A opening the door that utilizes the access control system.

FIG. 2A is front view of a door lock mechanism with a capaciflective sensor and a finger print reader utilized with the access control system.

FIG. 2B is an exploded view of the capaciflective sensor of FIG. 2A. FIG. 2C is a circuit employing the capaciflective sensor of FIG. 2A.

FIG. 3A is a diagrammatical view of a user approaching a door that utilizes another embodiment of the access control system.

FIG. 3B is a diagrammatical view of the user from FIG. 3A attempting to access the door that utilizes access control system of FIG. 3A.

FIG. 4A is a flow diagram one method used to determine if a user can access the controlled space.

FIG. 4B is a flow diagram of another embodiment of the access control system that allows the user to access the control space.

### DETAILED DESCRIPTION

The present application relates to a system that allows a user to seamlessly access a controlled space. In particular, the embodiments of the system disclosed allow the user to gain access to or from the controlled space without having to reach for and present a credential to a reader. The system is configured to reduce power consumption and extend battery life by utilizing devices, circuits and algorithms that ascertain user intent before or after detecting and authenticating one or more credentials that can be carried by or are biometric to the user. The system can also be adapted to detect and authenticate credentials as well as determine user intent in a predefined area adjacent the entry point to or exit point from the controlled space. In this manner, casual authorized users merely passing by the entry/exit will not be detected, thereby avoiding unauthorized entry to or exit from the controlled space. These and other features allow the system to reduce power consumption, enhance user convenience and enhance system security.

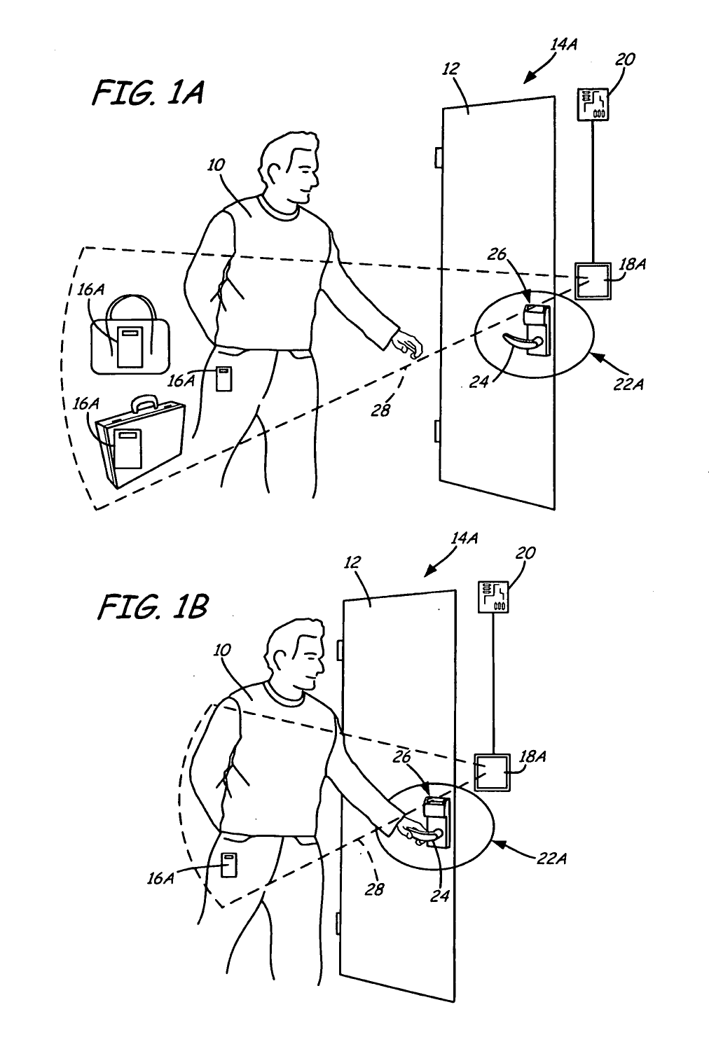

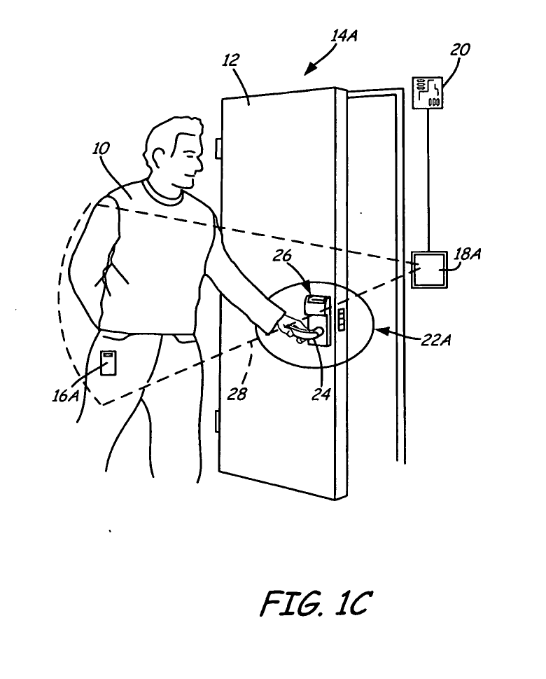

FIGS. 1A to 1C illustrate a user 10 approaching and opening a door 12 outfitted with an access control system 14A. The access control system 14A includes a credential 16A, a detection device 18A, a controller 20, and a sensor 22A disposed within or adjacent to a handle 24 of a lock mechanism 26. Detection device 18A produces beam pattern or signal pattern 28 that is focused to a region adjacent door 12. In other embodiments, the access control system 14A includes systems in which reader device 18A and controller 20 are integrated into the lock 26 and/or systems in which sensor 22A is part of reader device 18A.

Upon the approach of an authorized user 10 adjacent door 12, access control system 14A allows user 10 to seamlessly enter into or exit from a controlled space without having to present credential 16A to detection device 18A. In particular, when credential 16A is brought to a position adjacent detection device 18A by an attempt of the user 10 to enter or exit door 12, credential 16A and detection device 18A are configured to send and receive signals that are processed by controller 20 to authenticate user 10 and unlock lock mechanism 26 to grant user 10 access to the controlled space through door 12. The access control system 14A operates seamlessly because controller 20 is responsive to an user intent (as determined by sensor 22A) and detection device 18A to make an access decision (to allow or deny user 10 entry to the controlled space) within a short time period that is less than the time period it would take user 10 to reach out, grasp, and turn handle 24. In most embodiments, the time period between sensing user intent, authentication and the access decision is less than about 100 milliseconds.

In one embodiment, the authentication occurs after user 10 expresses user intent to enter/exit the controlled space through door 12. In this embodiment, user intent is sensed by one or more sensors 22A that are adapted to detect the presence of the hand of user 10 adjacent handle 24. In the embodiment illustrated in FIGS. 1A to 1C, sensor 22A is disposed adjacent handle 24 on lock mechanism 26. Sensor 22A can be configured to detect either contact (touch) between user 10 and handle 24 or the presence of the hand of user 10 within about 10 centimeters of handle 24. In FIG. 1B, sensed data regarding user 10 presence (indicative of user intent) is sent to controller 20 which then awakens detection device 18A from a reduced power mode to produce signal pattern 28 in the region adjacent the door 12. If detection device 18A detects the presence of credential 16A within this region, controller 20 then performs the authentication process to make the access decision to either grant or deny user 10 entry to or exit from the controlled space. As shown in FIG. 1B, the determination of user intent, the authentication process (and unlocking of lock mechanism 26) occurs so quickly that that they are completed prior to an attempt by user 10 to turn handle 24 or pull door 12 open. Thus, controller 20 is responsive to both detection device 18A and the sensor 22A to make the access decision prior to an attempt (illustrated in FIG. 1C) by the user to enter or exit the controlled space. Access control system 14A capability allows user 10 to enter or exit the controlled space without having to present credential 16A to detection device 18A. As illustrated in FIG. 1A, user 10 is broadly defined and can include an asset such as a laptop computer, purse, briefcase, cellular phone, file folder or any other equipment used in a work or leisure setting. Similarly, credential 16A can be any device capable of receiving and/or transmitting electromagnetic signals or could be a biometric credential such as a person's face (for facial detection), voice, retina, or fingerprint. Examples of devices capable of receiving and/or transmitting electromagnetic signals include: handheld devices, cellular telephones, wireless telephones, headsets, wrist communication devices, credit cards, personal computers, or pagers. Alternatively, credential 16A could be distinct from the asset and could be attached to virtually any item including the clothing of a person. In the embodiment shown in FIGS. 1A to 1C, credential 16A comprises a high or an ultra high radio frequency (RF) badge having an RF transmitter that is configured to send and receive far-field radio frequency signals. Credential 16A also has a microprocessor and other signal processing means that allows it to process and send and receive data signals. In other embodiments, credential can support other authentication means, for example it could act as a fingerprint reader. To minimize power consumption of the access control system 14A, the RF badge shown is a passive credential that is powered and has its memory content read and/or written when placed adjacent detection device 18A.

In the embodiment illustrated in FIGS. 1A to 1C, detection device 18A comprises an RF reader module with a transceiver and an antenna assembly. The antenna can comprise a commercially available mini-size antenna for use in the UHF (902-928) band. One such antenna is retailed by Snyder Antenna Systems, Inc. of Altadena, California as part number ANT-UHF-4×4-CP. The ANT-UHF-4×4-CP antenna is circularly polarized and is specified with a gain of 6 decibel isotropic circular (dBiC).

The reader module transmits and receives far-field radio frequencies to detect credential 16A. The antenna within the reader module can be designed to produce signal pattern 28 that is focused into a predefined shape such as the conical shape illustrated. This signal patterning or beam steering can be accomplished by known methods such as a phased antenna array, multiple beam antennas, or by switching antenna elements. Conical signal pattern 28 allows for detection of credential 16A within about 1 meter of reader module mounted adjacent door 12. By focusing signal pattern 28 to a predetermined region adjacent door 12, energy use is minimized and casual credentialed users 10 merely passing by door 12 at a distance will not be detected. In other embodiments, detection device 18A can house controller 20 and/or a second detection device such as a fingerprint reader or keypad. In yet another embodiment, the handle 20 can house a second detection device such as a fingerprint or hand geometry reader. Although not illustrated in the embodiment shown, detection device 18A can also be configured to house one or more sensors such as sensor 22A for identifying user intent.

Controller 20 is configured to communicate with both detection device 18A and sensor 22A and actuate components of lock mechanism 26. Controller 20 is responsive to both detection device 18A and the sensor 22A to make the access decision that can unlock lock mechanism 26 prior to an attempt (illustrated in FIG. IC) by the user to enter or exit the controlled space. Controller 20 can comprise, for example, a microprocessor, a microcontroller, or any hardware capable of processing input signals, making an access decision, and controlling lock mechanism 26 and other components. Controller 20 can be integrated with information systems technology to track user 10 movement, including aforementioned asset movement, throughout a workplace, company or organization.

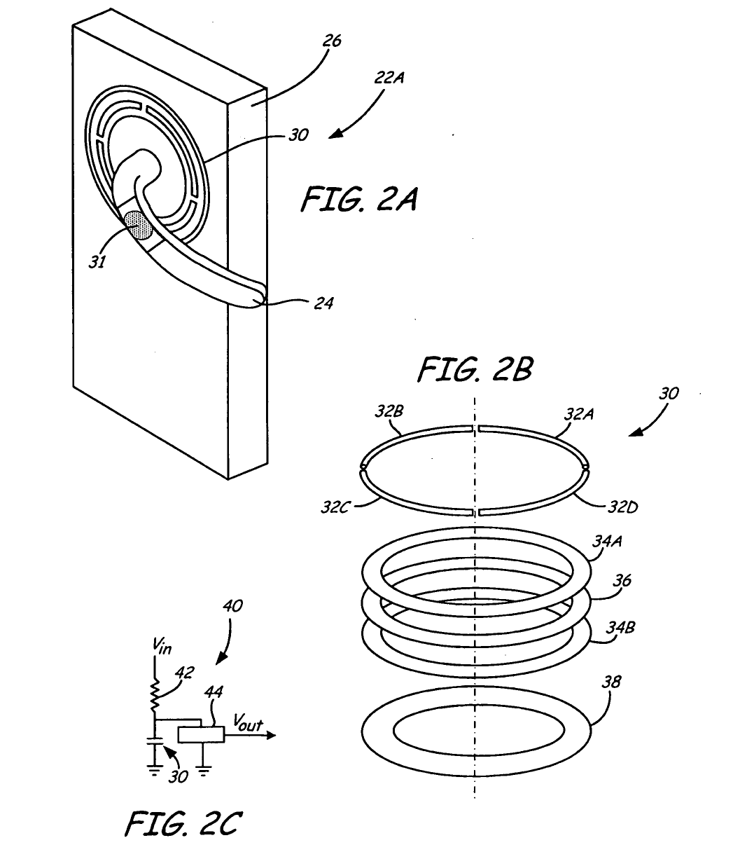

FIGS. 2A to 2C illustrate one embodiment of sensor 22A and second detection device. FIG. 2A shows sensor 22A as a capaciflective sensor 30 that is mounted in or on lock mechanism 26 adjacent to handle 24. A second detection device is illustrated as a conformal finger print reader 31 integrated into handle 24. FIG. 2B shows an exploded view of capaciflective sensor 30 which includes conductive elements 32A, 32B, 32C, and 32D, insulators 34A and 34B, shield plate 36, and ground plate 38. In FIG. 2C, capaciflective sensor 30 is integrated into a sensor circuit 40 which includes resistor 42 and operational amplifier 44.

Sensor 22A can comprise either a capacitive touch or capaciflective sensor 30 such as the one illustrated in FIGS. 2A to 2C. Capaciflective sensor 30 is capable of sensing the presence of an object at a distance therefrom. Capacitive “touch” sensors require physical contact in order to sense an object's presence. Such sensors are well known in the art and can be utilized in access control system 14A (FIGS. 1A-1C). Access control system 14A can also utilize a capaciflective sensor 30 that allows an object such as a hand to be sensed at a predetermined distance X away from the sensor.

Capaciflective sensors such as sensor 30 are known in the art. Examples of capaciflective sensors capable of being used in access control systems can be found in U.S. patent application No. 6,825,752 to Nahata et al., U.S. patent application Publication 2007/0281614 to Oliver et al., and U.S. patent application Publication 2008/0024312 to Richter, which are incorporated herein by reference.

FIGS. 2A to 2C illustrate an exemplary capaciflective sensor 30. Capaciflective sensor 30 is mounted adjacent lock mechanism 26 near handle 24 in FIG. 2A. In other embodiments, capaciflective sensor 30 can be disposed within handle 24 or a door knob or adjacent door 12 (FIGS. 1A to 1C).

FIG. 2B shows an exploded view of capaciflective sensor 30. In FIG. 2B, capaciflective sensor 30 has four sensor conductive elements 32A, 32B, 32C, and 32D. Each element 32A, 32B, 32C, and 32D comprises a sensor that forms an outer portion of capaciflective sensor 30. Conductive elements 32A, 32B, 32C, and 32D are disposed on an outer portion of capaciflective sensor 30 to interface with handle 24. Conductive elements 32A, 32B, 32C, and 32D are constructed from conductive materials such as metal or metal/polymer composites. Elements 32A, 32B, 32C, and 32D are electrically isolated from one another to create four discrete signals that are output to controller 20 (FIGS. 1A to 1C). Conductive elements 32A, 32B, 32C, and 32D are charged to create a voltage difference between them and ground plate 38. Insulators 34A and 34B comprising a dielectric material, such as a polymer, air or another insulative material; are disposed between conductive elements 32A, 32B, 32C, and 32D and shield plate 36 and between shield plate 36 and ground plate 38, respectively. Shield plate 36 comprises an actively shielded layer positioned between insulators 34A and 34B. Shield plate 36 is a conductor having a voltage about the same as the voltage of conductive elements 32A, 32B, 32C, and 32D. Due to this arrangement, shield plate 36 causes the electric field generated by the voltage differential to extend from conductive elements 32A, 32B, 32C, and 32D, around shield plate 36, ultimately to ground plate 38. Objects in this electric field (such as a human hand reaching for handle 24 illustrated in FIG. 1B) will change the field, causing a change in the dielectric constant and capacitance, which is read as the presence of the object.

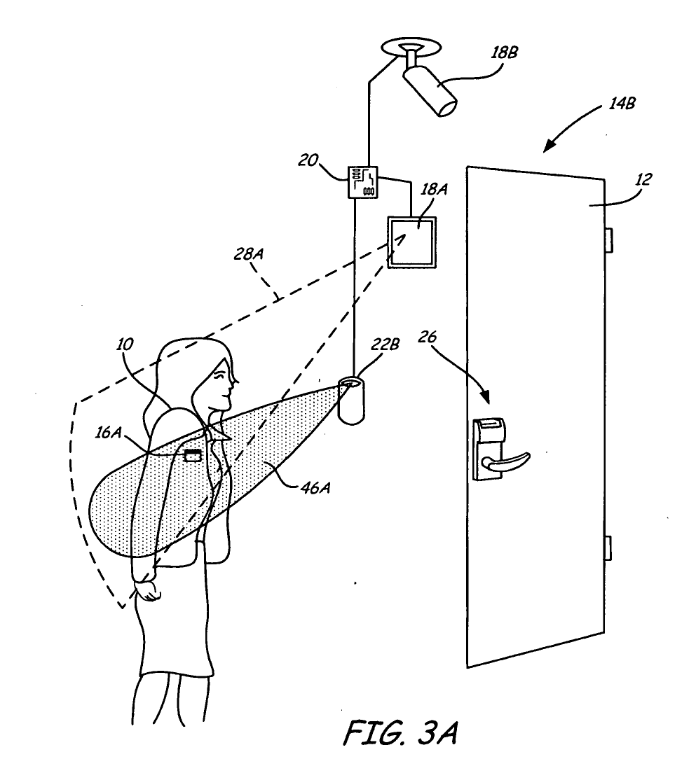

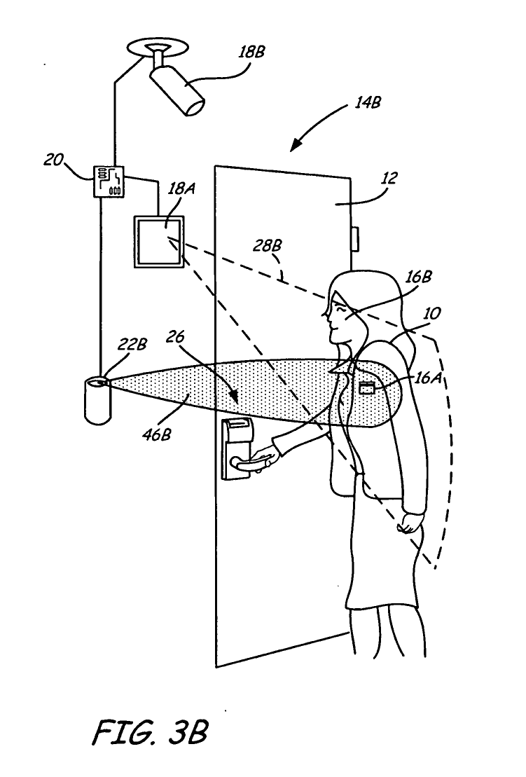

FIG. 2C illustrates capaciflective sensor 30 integrated into sensor circuit 40. Capaciflective sensor 30 is connected to resistor 42 and operational amplifier 44. Operational amplifier 44 is part of sensor circuit 40 to maintain about the same voltage between one element 32A, 32B, 32C, and 32D and shield plate 36 when an object is not present within sensing range of the capaciflective sensor 30. Together capaciflective sensor 30 and resistor 42 form an RC circuit with a frequency of 1/RC. The 1/RC frequency changes with the change in capacitance that is caused by an object within sense range. Operational amplifier 44 outputs a signal, which has a frequency related to 1/RC that is communicated to controller 20. In the embodiment shown, four signals from four circuits 40 would be outputted to controller 20 as four channels. Controller 20 compares the detected frequencies from circuits 40 with a predetermined threshold frequency. In particular, software counts the number of waves every unit of time and compares the detected frequencies with the predetermined threshold frequency. When the detected frequency from one or more channels moves below the predetermined threshold frequency, controller 20 responds by awakening detection device 18A or by making the access decision that can unlock lock mechanism 26 prior to an attempt (illustrated in FIG. 1C) by the user to enter or exit the controlled space. The predetermined threshold frequency can be set in software, and hence, can be changed to make the range of detection adjustable from a maximum value to a minimum value that can be a touch by the hand of user 10. Once the presence of user 10 is sensed and processed, controller 20 can wake detection device 18A or can actuate detection device 18A to detect credential 16A for authentication, and then make the access decision. FIG. 3A shows user 10 approaching door 12 that utilizes another embodiment of an access control system 14B. FIG. 3B shows user 10 accessing door 12 that utilizes access control system 14B. In addition to first credential 16A and first detection device 18A, the embodiment of access control system 14B includes a second credential 16B (includes biometric identity such as a face of user 10), a second detection device 18B, a sensor 22B, a first signal pattern 28A, a second signal pattern 28B, a first detection region 46A, and a second detection region 46B.

In access control system 14B, sensor 22B comprises a passive infrared (PIR) sensor that is capable of detecting the presence of user 10 adjacent door 12. Sensor 22B passes the detection information on to controller 20. Controller 20 is responsive to the detection information from PIR sensor 22B to awaken and direct the first detection device 18A, comprising the RF reader module outputting an RF signal, toward the user 10 to read first credential 16A. Directing or steering of the RF signal can be accomplished using methods know in the art such as a phased antenna array, multiple beam antennas, or by switching antennal elements. When PIR sensor 22B detects approach of user in first detection region 46A, RF antenna outputs first signal pattern 28A directed in the same general direction as first detection region 46A toward user 10 to read credential 16A. In this manner, energy consumption of the RF reader module is reduced. Additionally, communications accuracy between RF reader module and credential 16A is improved as the RF signals are more focused, thereby transferring more energy to credential 16A. Controller 20 also is adapted to direct RF receiver to track with user 10 movement (as detected by PIR sensor 22B) once user 10 presence has been sensed adjacent door 12. For example, as user 10 moves to another position, illustrated in FIG. 3B, user 10 enters second detection region 46B, and controller 20 directs RF reader module to produce second signal pattern 28B which is directed toward user 10 to read credential 16A. This configuration improves return path sensitivity allowing RF reader module to better receive signals from credential 16A.

PIR sensor 22B is of conventional construction and is adapted to receive and measure infrared light radiating from objects in its field of view. PIR sensors are known in the art and are commonly used as motion detectors. PIR sensors commonly employ a pyroelectric sensor chip that can output a signal to controller 20, which is configured to interpret the output signal. PIR sensor 22B can employ lenses such as a Fresnel lens or mirrors such as segmented parabolic mirrors to focus infrared reception to regions such as first detection region 46A and second detection region 46B. First and second detection regions 46A and 46B extend adjacent door 12 as illustrated in FIG. 3. Access control system 14B may include a plurality of detection regions in addition to first detection region 46A and second detection region 46B. Once user 10 presence (indicative of user intent) is detected adjacent door 12 by PIR sensor, access control system 14B authenticates user as discussed previously save for the addition of second detection device 18B and second credential 16B.

To complete authentication and allow user 10 access to the controlled space, second detection device 18B must detect second credential 16B. In the embodiment illustrated in FIG. 3, second credential 16B comprises the face of the user 10. Thus, second credential 16B is a biometric credential. Second detection device 18B is a video camera configured to capture images of user 10, and in particular the face of the user 10, as user 10 approaches door 12. The video camera outputs a signal to controller 20, which is configured with facial recognition software to interpret the output signal and ascertain whether or not user 10 is authorized to access the controlled space. Authentication of second credential 16B can occur in any order with respect to detection/authentication of first credential 16B and detection by sensor 22B. For example, by approaching door 12 the face of user 10 maybe recognized as authorized by controller 20 which runs facial recognition software. Thus, by merely approaching door 12 or coming within range of camera, user 10 completes one step of the authentication process. Facial authentication can occur before user 10 is sensed by PIR sensor and before first detection device 18A (in this instance RF reader) detects first credential 16A. However, authentication and detection of user intent should occur prior to an attempt by user to turn handle or pull door open to make the entry process seamless for user 10. Thus, controller 20 is responsive to both detection devices 18A and 18B and sensor 22B to make the access decision prior to an attempt by the user to enter or exit the controlled space.

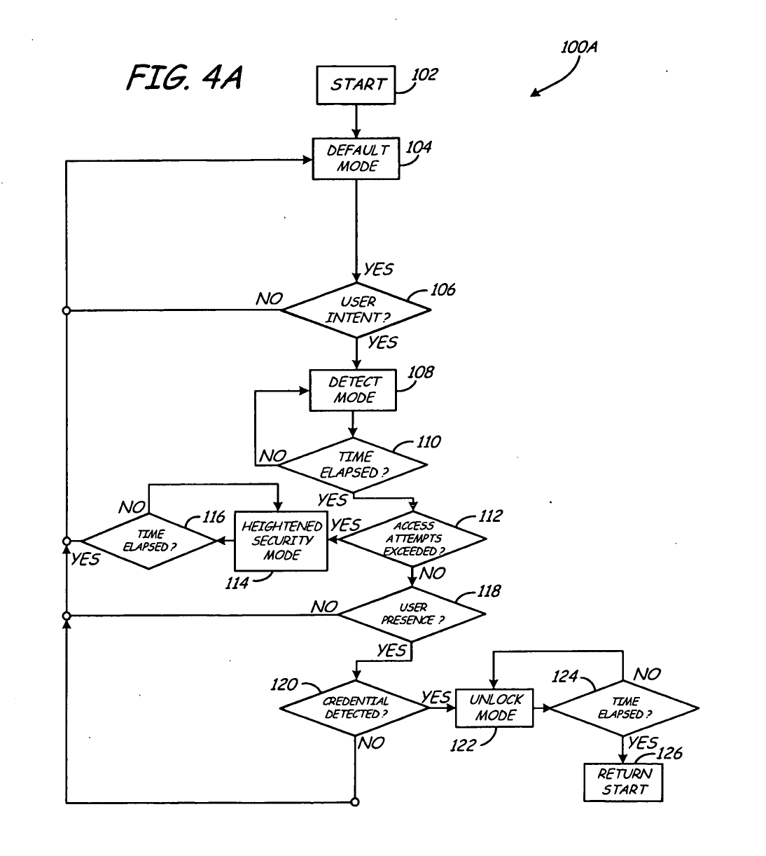

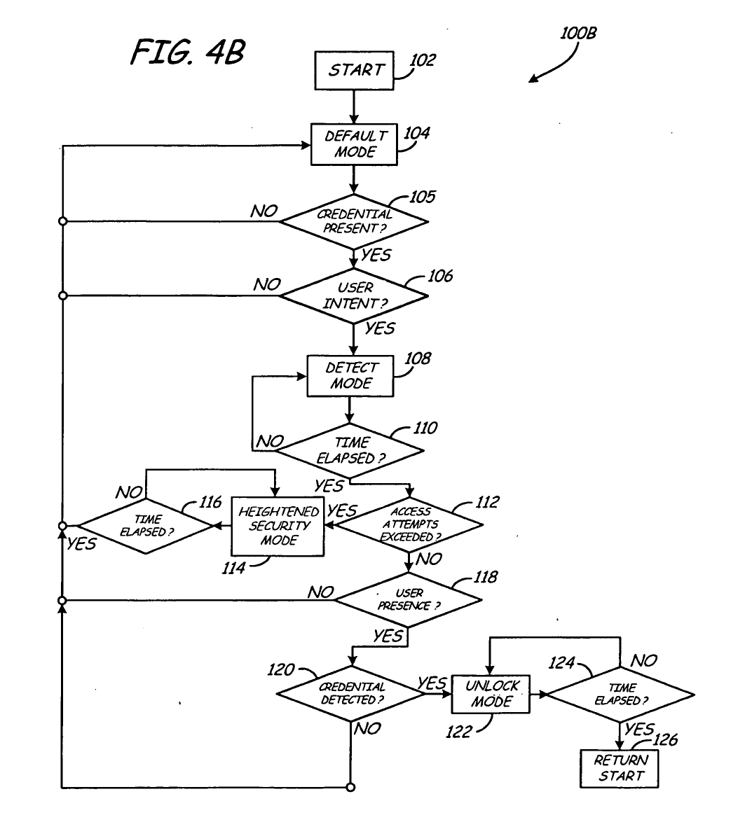

FIG. 4A shows a flow diagram of one method 100A used to determine if user can access the controlled space. Method 100A starts at block 102 and proceeds to state block 104. In state block 104, first sensor is in a low power mode, generally between 1 and 10 percent duty cycle. Lock mechanism is in a locked state of operation that does not allow access to or from the controlled space. From state block 104, method 100A moves to query block 106. Query block 106 determines whether user is present utilizing one or more sensors. Sensed user presence is indicative of user intent to access the controlled space. Criteria indicative of presence or used in addition thereto can be used in query block 106 to ascertain if user has sufficient clearly expressed intent to enter controlled space. Indicative criteria can include: a time the user spends attempting to access the controlled space, a movement or series of movements of the user as detected by the sensor, the number of frequencies that dip below the predetermined frequency as discussed previously with regard to capaciflective sensor shown in FIGS. 2A to 2C, a contact or range between the sensor and the user, a direction or angle or approach toward the sensor by the user, an identity of the user (such as biologically identifying features like the user's face or fingerprint), the application the system is utilized in or the security level the system is set for, a location of the sensor within a structure such as a building, or a vibration caused by the user. If sufficient user intent to enter controlled space is determined, method 100A proceeds from query block 106 to state block 108. In state block 108, second sensor is awoken and begins to detect. Similarly, detector is awoken and begins to detect. In other embodiments with no second sensor, only detector is awoken or a plurality of detectors are awoken in state block 108. From state block 108 method 100A moves to query block 110. Query block 110 determines if more than a predetermined time period has elapsed since method 100A entered state block 108. In one embodiment this time period is about 10 seconds. If the predetermined time period has not yet elapsed, method 100A remains in state block 108. If the predetermined time has been exceeded, method 100A proceeds to query block 112. Query block 112 ascertains if less than a predetermined number of attempts to access the controlled space have occurred since the sensor or detector was awoken. In one embodiment, the predetermined number of attempts is three. In other embodiments, query block 112 can ascertain if excessive vibration is occurring to lock mechanism. Similar to exceeding the predetermined number of attempts to access the controlled space, excessive vibration can be determinative of a malicious attempt to gain entry to the controlled space. In method 100A shown in FIG. 4A, if more than the predetermined number of attempts to access the control space occur, method 100A moves to state block 114. State block 114 comprises a heightened security level mode. In this mode, power to sensor(s) or detector(s) can be substantially reduced or eliminated to that of a shutdown mode. From state block 114 method 100A proceeds to query block 116 which ascertains if less than a predetermined time has elapsed since method 100A entered state block 114. If less than the predetermined time has elapsed, method 100A remains in the shutdown mode. If more than the predetermined time has elapsed, method 100A proceeds from query block 116 to state block 104.

If less than the predetermined number of attempts to access the controlled space have occurred, method 100A moves from query block 112 to query block 118. Query block 118 ascertains if the presence of the user is detected with the second sensor, awoken in state block 108. Alternatively, query block 118 can ascertain if a first credential is detected by a first detector. If the presence of user is not detected, method 100A proceeds from query block 118 back to state block 104. If the presence of the user is detected, method 100A proceeds to query block 120 which ascertains if a credential is detected by first detector or in some instances if a second credential is detected by a second detector. From query block 120, method 100A moves to state block 122, which comprises an unlock state. In unlock state, user can freely access the control space through door or similar portal. Query block 124 determines if less than a predetermined time period has elapsed since method 100A entered state block 122. In one embodiment, predetermined time period comprises about 5 seconds. Once predetermined time period has elapsed, method 100A moves to block 126 which returns method to block 102.

FIG. 4B shows an alternative method 100B used to determine if user can access the controlled space. Method 100B is identical to method 100A with the exception that query block 105 has been added. Query block 105 determines if a first credential is present. In one embodiment, this credential is the face of the user for facial recognition purposes. Method 100B then proceeds to query block 106, which determines user intent based upon detecting user presence with one or more sensors. If user presence is sensed, method 100B proceeds from query block 106 to state block 108. In state block 108, a second sensor or a second detector (or both) are awoken and begin to detect. Method 100B continues to proceed in a manner similar to that of method 100A.

Although the present invention has been described with reference to preferred embodiments, workers skilled in the art will recognize that changes may be made in form and detail without departing from the spirit and scope of the invention.

1. A system for providing access to or from a controlled space, comprising:
a credential associated with or carried by a user;
a device configured to detect the credential;
a sensor adapted to detect the presence of the user adjacent an entrance to or exit from the controlled space; and
a controller responsive to both the device and the sensor to make an access decision prior to an attempt by the user to enter or exit the controlled space.

2. The system of claim 1, wherein the sensor comprises a plurality of sensors, the device comprises a plurality of devices, and/or the credential comprises a plurality of credentials, and wherein the plurality of devices and/or the plurality of sensors are used to both detect an intent of the user to access the controlled space and to authenticate an identity of the user.

3. The system of claim 1, wherein the sensor or device comprises at least one of: passive infrared, acoustic, video, electromagnetic, radio frequency, optical, capacitive, capaciflective, or inductive, and wherein the sensor or the device is used by the controller to authenticate the identity or presence of the user.

4. The system of claim 3, wherein the capaciflective sensor has multiple sensor elements, each sensor element outputs a signal to the controller.

5. The system of claim 1, wherein the controller determines an intent of the user to access the controlled space based upon at least one of: a predetermined time the user spends attempting to access the controlled space as detected by the sensor, a distance between the sensor and the user, a contact between the sensor and the user, a direction or angle or approach toward the sensor by the user, an identity of the user, an application the system is implemented in, a location of the sensor within a structure, or a vibration caused by the user.

6. The system of claim 5, wherein user intent to access the controlled space is determined prior to the device detecting the credential.

7. The system of claim 5, wherein user intent to access the controlled space is determined either to be a valid intent whereby the controller signals a lock mechanism to open or a malicious intent whereby the controller signals the reader module to enter a low power mode or a lockout mode.

8. The system of claim 1, wherein the credential is a radio frequency card that sends and receives signals and is configured to be worn or carried by the user of the system.

9. The system of claim 8, wherein the credential comprises a biometric credential or a passive credential.

10. The system of claim 8, wherein the device comprises a radio frequency reader module that sends and receives signals to detect the credential and the controller is responsive to a passive infrared sensor to direct the signals of the reader module toward the user.

11. The system of claim 1, wherein the sensor comprises a finger print reader that is integrated into a handle or knob of the door.

12. The system of claim 1, wherein the user comprises an asset.

13. A method for providing access to or from a controlled space, comprising:
detecting a credential that identifies a user;
authenticating the user based upon the credential;
determining a user intent to access the controlled space based on a presence of the user adjacent an entrance to or exit from the controlled space; and
controlling a lock mechanism to unlock or remain locked based on both the credential and the user intent.

14. The method of claim 13, wherein the presence of the user is determined by one or more sensors.

15. The method of claim 13, wherein user intent is determined by at least one of: a predetermined time the user spends attempting to access the controlled space as detected by a sensor, a number of sensors, a distance between a sensor and the user, a contact between a sensor and the user, a direction or angle or approach toward a sensor by the user, an identity of the user, an application the system is used in, a location of the sensor within a structure, or a vibration caused by the user

16. The method of claim 13, wherein user intent to access the controlled space is determined prior to the device detecting the credential.

17. A system for providing access to or from a controlled space, comprising:
a credential that sends and receives signals and is configured to be worn or carried by a user;
a reader module that sends and receives signals to detect the credential;
a passive infrared sensor adapted to detect the presence of the user adjacent an entrance to or exit from the controlled space; and
a controller responsive to the passive infrared sensor to direct the signals of the reader module toward the user, wherein the controller is responsive to both the passive infrared sensor and reader module to make an access decision prior to an attempt by the user to enter or exit the controlled space.

18. The system of claim 17, and further comprising a second sensor adapted to detect the presence of a user adjacent an entrance to or exit from the controlled space or a second credential capable of being detected by a second device.

19. The system of claim 17, wherein the controller determines a user intent to access the controlled space based upon at least one of a predetermined time the user spends attempting to access the controlled space as detected by the sensor, a distance between the sensor and the user, a contact between the sensor and the user, a direction or angle or approach toward the sensor by the user, an identity of the user, an application the system is used in, a location of the sensor within a structure, or a vibration caused by the user.

20. The system of claim 19, wherein the user intent to access the controlled space is determined to either be a valid intent whereby the controller signals a lock mechanism to open or a malicious intent whereby the controller signals the reader module to enter a low power mode or a lockout mode.
